(19) United States
(12) Patent Application Publication
(10) Pub. No.: US 2012/0098294 A1
(43) Pub. Date: Apr. 26, 2012

(54) MULTIPLE LAYER TRIM DOOR MODULE

(76) Inventors: Michael Dancasius, Wuppertal (DE); Christian Ruegen, Tonisvorst (DE); Geoff Barr, Troy, MI (US)

(21) Appl. No.: 13/226,984

(22) Filed: Sep. 7, 2011

Related U.S. Application Data
(60) Provisional application No. 61/380,508, filed on Sep. 7, 2010.

(51) Int. Cl. B60J 5/00; B32B 37/18

(52) U.S. Cl. 296/146.6; 156/242

(57) ABSTRACT

A multiple layer trim door module for a vehicle door is provided, the multiple layer trim door module having: a separately formed structural member having at least one column and at least one bar crossing each other to form a structural space frame grid, wherein the separately formed structural member is formed by a plastic molding process wherein the at least one column and at least one bar have a first structural rigidity associated therewith; a separately formed trim back plate with reduced structural properties attached to the structural member, wherein the separately formed trim back plate is formed by a plastic molding process and the separately formed trim back plate has a second structural rigidity associated therewith, the second structural rigidity being less than the first structural rigidity; and door trim with reduced structural properties attached to trim back plate.

### CROSS-REFERENCE TO RELATED APPLICAITONS

This application claims the benefit of U.S. Provisional Patent Application Ser. No. 61/380,508 filed Sep. 7, 2010 the contents of which are incorporated herein by reference thereto.

### BACKGROUND

Exemplary embodiments of the present invention relate to assemblies for vehicle doors and more particularly to a door module for a vehicle door.

In a vehicle door there are many elements with important structural support for example: the door; the door module; and trim and door components (conventional door trim also present additional structural supports).

Accordingly, it is desirable to provide a door trim module that integrates existing structural elements in a unique manner that negates the need for other structural areas or elements.

### SUMMARY OF THE INVENTION

In accordance with an exemplary embodiment of the present invention, a multiple layer trim door module for a vehicle door is provided, the multiple layer trim door module having: a separately formed structural member having at least one column and at least one bar crossing each other to form a structural space frame grid, wherein the separately formed structural member is formed by a plastic molding process wherein the at least one column and at least one bar have a first structural rigidity associated therewith; a separately formed trim back plate with reduced structural properties attached to the structural member, wherein the separately formed trim back plate is formed by a plastic molding process and the separately formed trim back plate has a second structural rigidity associated therewith, the second structural rigidity being less than the first structural rigidity; and door trim with reduced structural properties attached to trim back plate and/or the structural member, wherein the door trim has a third structural rigidity associated therewith, third structural rigid the being less than the first structural rigidity.

In accordance with another exemplary embodiment of the present invention, a method forming a multiple layer trim door module is provided, the method including the steps of: separately forming a structural member having at least one column and at least one bar crossing each other to form a structural space frame grid, wherein the separately formed structural member is formed by a plastic molding process wherein the at least one column and at least one bar have a first structural rigidity associated therewith; separately forming a trim back plate with reduced structural properties attached to the structural member, wherein the separately formed trim back plate is formed by a plastic molding process and the separately formed trim back plate has a second structural rigidity associated therewith, the second structural rigidity being less than the first structural rigidity; forming door trim with reduced structural properties, wherein the door trim has a third structural rigidity associated therewith, the third structural rigid the being less than the first structural rigidity; securing the separately formed structural member to the separately formed trim back plate; and securing the door trim to the separately formed trim back plate and/or the structural member.

### BRIEF DESCRIPTION OF THE DRAWINGS

FIG. 1 is an exploded perspective view of an exemplary embodiment of the present invention;

FIG. 2 is an exploded perspective view of another exemplary embodiment of the present invention;

FIG. 3 is an outboard view of an embodiment of the present invention;

FIG. 4 is an inboard view of an embodiment of the present invention;

FIGS. 5-7 are views of a structural member of various exemplary embodiments of the present invention;

FIG. 8 is an inboard view of an embodiment of the present invention in a vehicle door; and

FIG. 9 is an outboard view of an embodiment of the present invention in a vehicle door.

Although the drawings represent varied embodiments and features of the present invention, the drawings are not necessarily to scale and certain features may be exaggerated in order to illustrate and explain exemplary embodiments the present invention. The exemplification set forth herein illustrates several aspects of the invention, in one form, and such exemplification is not to be construed as limiting the scope of the invention in any manner.

### DETAILED DESCRIPTION OF EXEMPLARY EMBODIMENTS

As illustrated in the attached FIGS., a multi layer door trim module or door module 10 is illustrated in an exploded view. The multi layer door trim module 10 has a separately formed structural member 12, a separately formed trim back plate or trim base carrier 14 and separately formed door trim identified as 16.

In one embodiment, the defined structural layers (which take into consideration the technological aspects, too) optimally combine structural, design, styling and other requirements for different content and markets, contemplated for the door trim module 10.

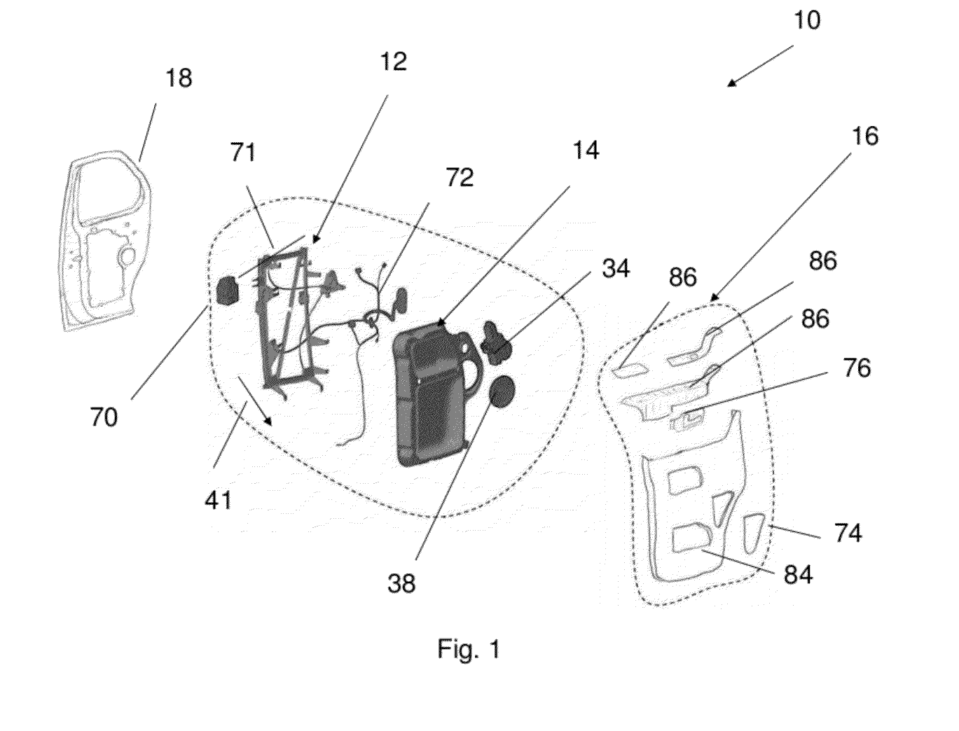

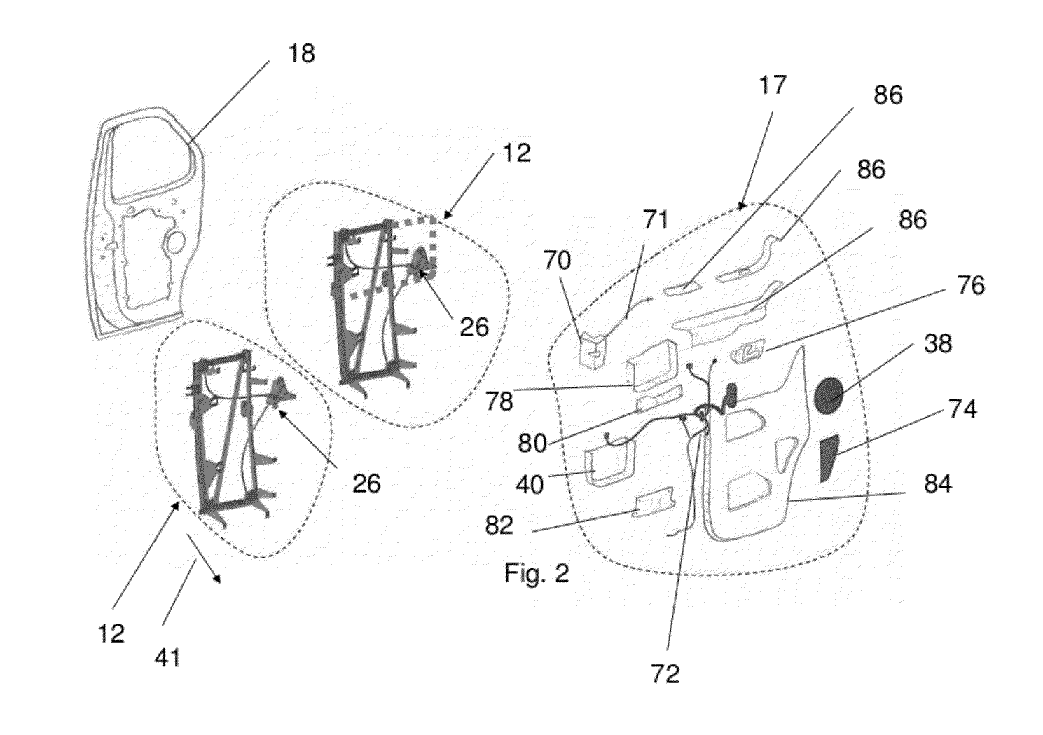

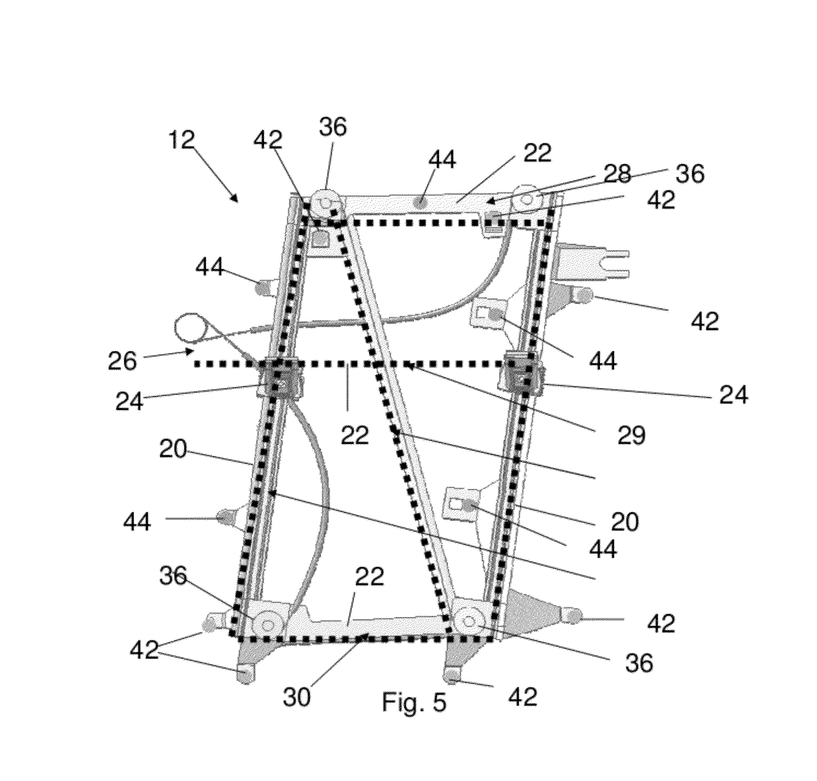

The first layer or structural member 12 provides a closed structural space frame, with increased structural properties as opposed to other components of the door module. This first layer is also illustrated in FIGS. 1 and 2 as well as FIGS. 5, 6, 7.

The structural member 12, which is attached to the door 18 provides optimal support to fulfill all static and dynamic requirements for the trim, and/or window regulator, and/or door system. The structural member 12 is designed as a closed space frame integrating simple “columns” 20 and “bars” 22 which form a structural space frame grid (crossing each other).

The structural columns and bars are designed preferably straight with simple cross sections (I; T; double T; U; L; or combinations thereof). In addition, theses columns and bars are formed in conjunction with the cost effective manufacturing technologies for example; compression molding and efficient use of structural requirements required for the door module. For example and in one embodiment, the columns and bars are integrally formed as a single structural member 12. Alternatively, the columns and bars are separately formed and secured together to form the single structural member 12. In one exemplary embodiment, the columns and bars of the structural member 12 are formed from an easily molded material such as plastic using injection or compression molding, plastic molding process or equivalents thereof. In yet another alternative embodiment, the columns and bars are formed from metals or metal alloys using the aforementioned injection or compression molding processes or other alternative methods for forming the columns and bars out of metal and/or plastic.

In one embodiment, optimal structural support is provided to the structural member in order to implement efficient use of materials in critical areas using molding or forming technologies such that structural support is provided in critical areas while also providing a lightweight and cost-effective structural member.

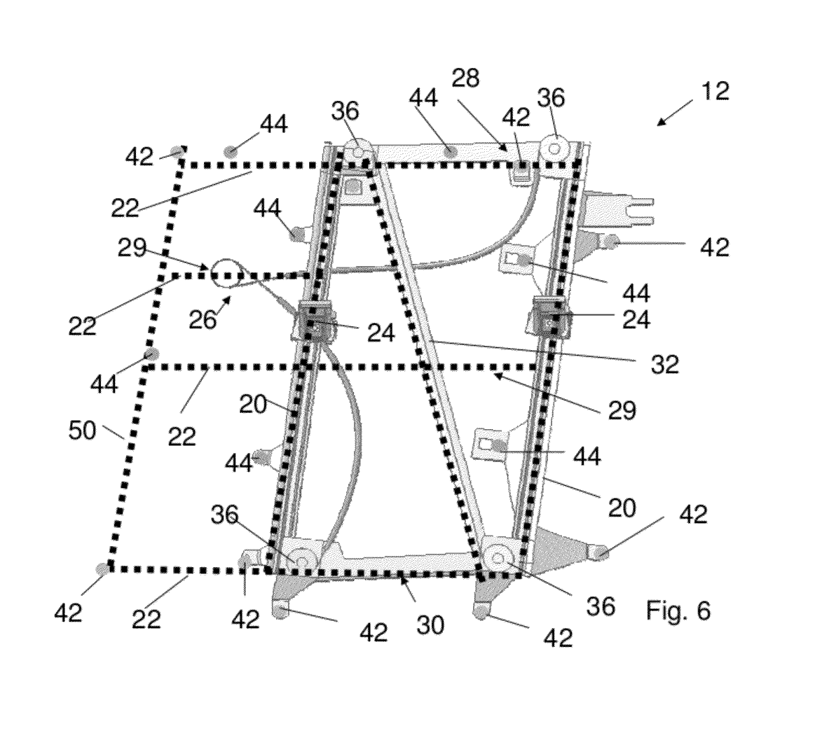

FIG. 5 illustrates an example of a structural member 12 with a closed frame while FIG. 6 illustrates an example of an extended structural member 12 with a closed frame. FIG. 2 also illustrates two structural members 12 one having the extended structural frame illustrated by dashed lines while the other structural member illustrates an unextended structural frame.

The number, position, cross-sectional configuration, etc. of the “bars” and “columns” of the space frame member 12 are dependent upon the design, styling, requirements, market, etc. wherein the door module or door trim module 10 is to be used such that a lightweight and cost-effective door trim or door module is provided.

The structural member 12 contains and integrates: at least 2 columns 20, vertically or substantially vertically or vertically inclined and/or parallel with a glass run channel 21, which can be integrally formed with the columns 20 or comprise a separate item secured to the structural member 12. In one embodiment, the columns 20 are configured to integrate guide rails 24 of a cable window lift system 26. In one embodiment the cable window lift system 26 may have one or two guides 24, each of which are configured to slide within front and/or rear window guide channels of the front and/or the rear trim side-support.

The structural member 12 also contains and integrates: at least 2 beams 22, which in one embodiment are preferably horizontal however, non-horizontal arrangements are also contemplated to be within the scope of exemplary embodiments of the present invention. The bars 22 can be configured to integrate an upper belt line (trim-support and upper window cable lift attachment) and a lower trim support and lower window lift attachments. For example and referring at least to FIGS. 5-7, an upper structure 28 comprising bar 22 is provided and located at the belt line and/or provides a structural support for an inside door handle to be secured thereto. In addition, a lower structure 30 is also provided. Upper structure 28 and lower structure 30 are illustrated in at least FIGS. 5-7. In addition, a mid-structure 29 is also provided, the mid-structure may provide structural support to an arm rest, speaker and/or map pocket and/or drum housing and is preferably arranged in a horizontal fashion similar to the upper structure 28 and the lower structure 30.

The structural member 12 also contains and integrates at least one diagonal support 32. The at least one diagonal support 32 can provide a variety of functions in addition to structural support to the structural member 12. For example it can act as a cable guide, provide integrated supports for cable window lift system components as well as door trim parts. Non-limiting examples of such system components and/or trim parts include: drum housing; electric motor 34; cable guides; pulleys 36; studs; speaker 38; armrest; map-pocket 40; routing channels for cables and wires; fastening devices for different housings and components (e.g., electric wiring, electronic devices etc.).

The structural member 12 is preferably manufactured by injection or compression molding. Of course, other molding processes are contemplated to be within the scope of exemplary embodiments of the present invention. In one embodiment, the structural member 12 is formed from reinforced plastic having a high glass content. For increased structural requirements (e.g., high loads) the frame of the structural member 12 can be locally reinforced by additional mould-in inlays (metal, glass mat, plastic, etc.).

The window lift and/or window guide channels (structures already available) provides significant structural support which are thereby “implemented” in the door trim support frame structure. In other words, the rails (e.g., vertical and horizontal bars) are currently used in door modules and exemplary embodiments of the present invention remove these components to provide a separately formed structural member 12.

In addition, and referring at least to FIGS. 5-7, the structural member 12 has a plurality of mounting features 42 configured for securing the structural member 12 to the door module 18. Still further, the structural member 12 will have a plurality of mounting features 44 configured to secure the same to the trim base carrier 14.

In one exemplary embodiment, features 42 and 44 are integral tab members formed with the columns and bars. In one embodiment, the integral tab members extend outwardly away from the structural member 12. Still further and as illustrated in at least FIGS. 1 and 2, the integral tab members extend away from the structural member 12 in the direction of arrow 41 such that the structural member 12 is spaced from a surface of the trim back plate or carrier 14.

In accordance with one embodiment and since structural support is provided by structural member 12, the trim does not need to be designed with significant structural support yielding flexible styling and implementation of effective high volume technologies for the trim pieces to be secured to the structural member 12.

Moreover, the attachment of the structural frame 12 to the door 18 improves the rigidity and resistance of the trim and door system.

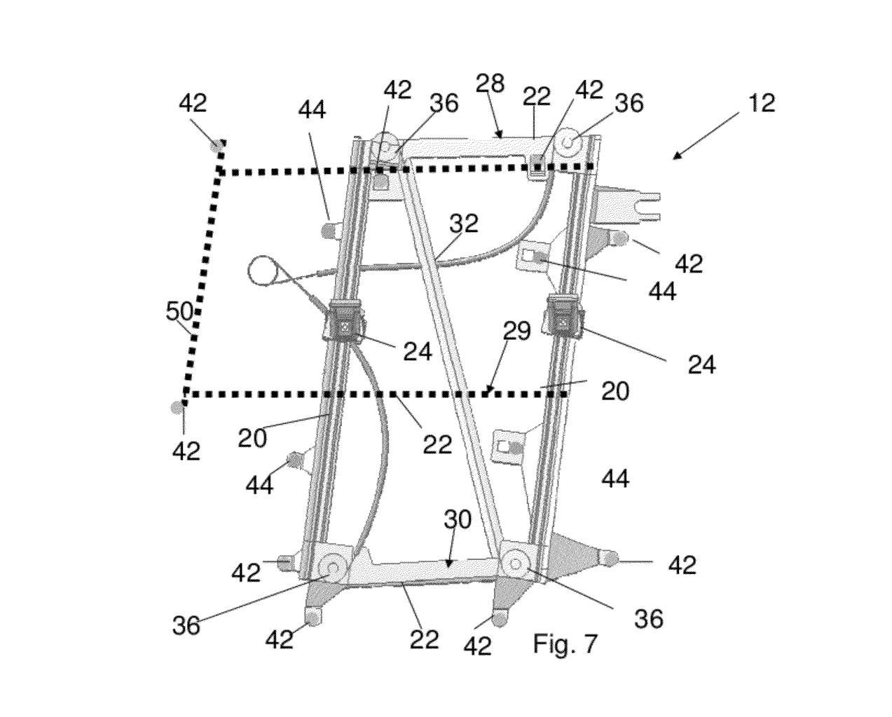

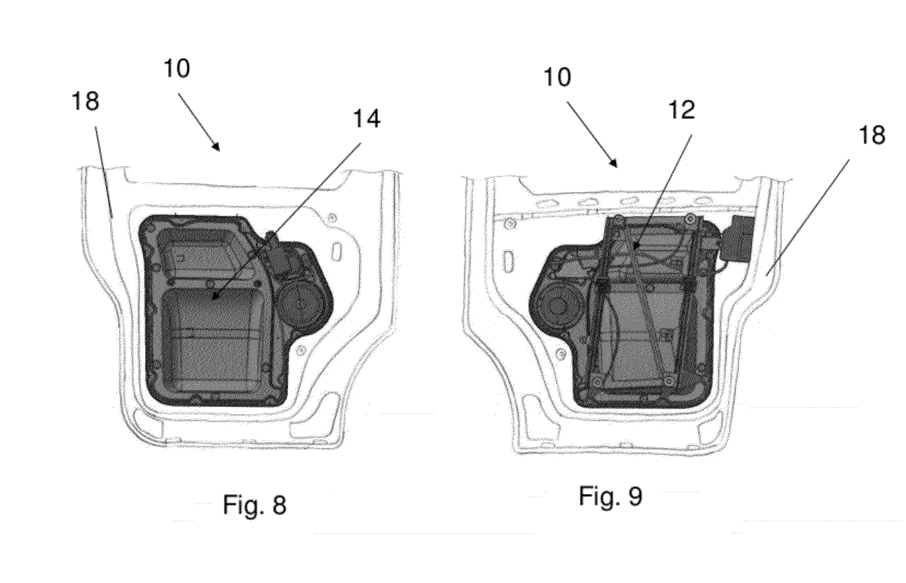

In an alternative embodiment and referring to FIGS. 6 and 7, the structural member 12 has an extended structure wherein the upper structure 28, mid-structure 29 and lower structure 30 are extended and a glass run channel 50 is provided. Similar to the columns 20 glass run channel 50 runs in a somewhat vertical fashion and is parallel to the other columns 20. As illustrated in FIG. 6, mid-structure 29 is secured to glass run channel 50 and one of the other columns 20. Alternatively and as illustrated in FIG. 7, mid-structure 29 extends across all three vertical columns 20 however and in this embodiment the glass run channel 50 only extends from the upper structure 28 to the mid-structure 29.

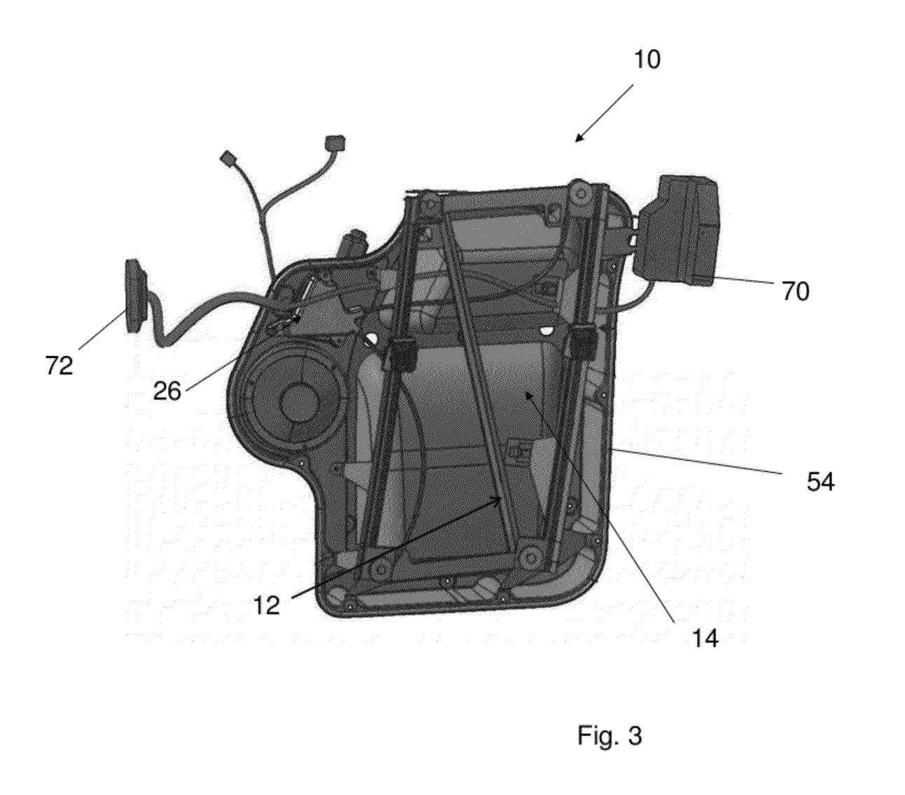

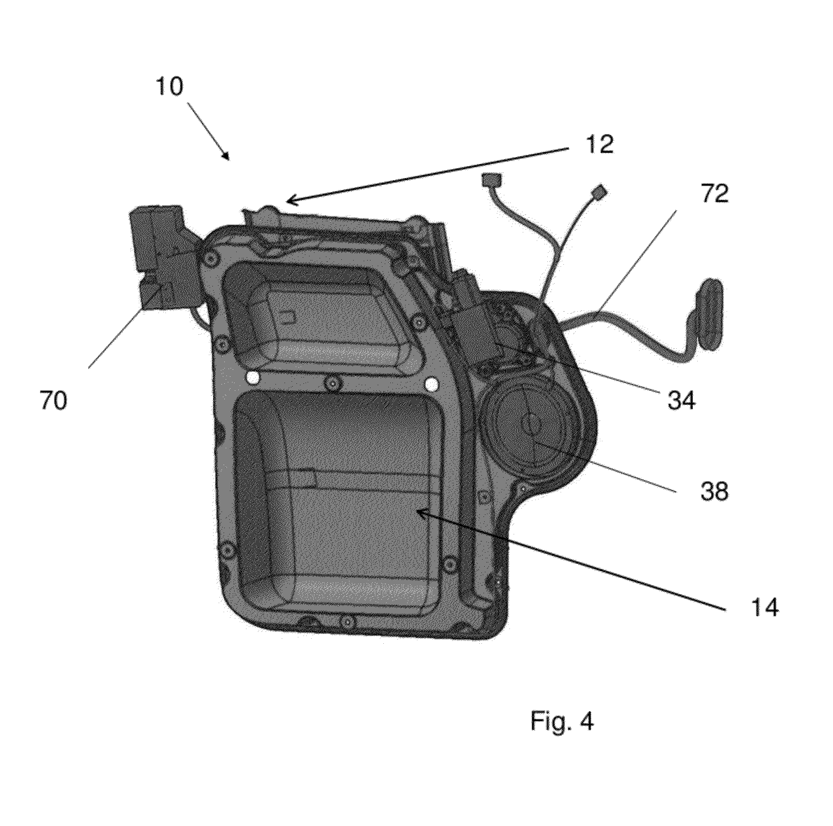

Referring back now to at least FIGS. 1-4 and 6-7, the trim back plate or carrier 14 with reduced structural properties is illustrated. As used herein, reduced structural properties means that the trim back plate or carrier 14 provides significantly or substantially less structural rigidity or support to the door module or door trim module than the structural support member 12. For example and one non-limiting exemplary embodiment, the structural member 12 may be formed with a fiber reinforced plastic material while the components of the trim back plate or carrier 14 and the door trim 16 are formed from non-fiber reinforced plastic materials such that the trim back plate or carrier 14 and door trim 16 provide significantly or substantially less structural rigidity or support to the door module. However, the trim back plate or carrier 14 and door trim 16 can now be formed by materials that provide aesthetically pleasing parts since the same are not required to provide structural aspects or features to the door module.

The trim back plate or carrier 14 is attached to the structural member 12 and/or the door 18 and forms a backing plate for the door trim 16. In other words, the trim back plate or carrier 14 creates the back areas of the map pockets and/or other trim areas having visible areas. In addition, the trim back plate or carrier 14 is also configured to have a seal 54 that creates or separates the wet and dry areas of the door module.

In addition, the trim back plate or carrier 14 also can be implemented as a “shipping” support for door parts, while the main structural support is provided by the attachment to the door 18 and/or to the structural support member 12.

The door trim 16 comprises one or more trim parts with adequate styling (surface, touch, color, shape, etc.). In accordance with an exemplary embodiment and through the use of structural member 12 and trim base carrier 14, and the one or more trim parts can be configured with reduced structural properties since the trim parts alone do not need to fulfill any significant structural requirements with respect to the door module and thus this allows for: implementation of high volume cost effective technologies for “nice looking parts” or aesthetically pleasing parts (for example, film coating, back injection molding, back compression molding, etc.). These processes provide less rigid or less structurally sound parts. Still further and since structural properties are not required, flexible styling using different content for different requirements and/or markets can be implemented since and easy attachment of the door trims to the trim back plate and/or structural member are provided. The trim can be secured to the structural member 12 and/or the trim back plate or carrier 14. Accordingly, the trim 16 can be secured to both the structural member 12 and the trim back plate or carrier 14 or only one of the structural member 12 and the trim back plate or carrier 14.

In addition and since the trim back plate or carrier 14 is separately formed and does not require higher structural characteristics it can be formed by different technologies than those of the structural member 12. Non-limiting examples of such technologies include: injection or compression moulding, thermo forming, plastic molding processes and equivalents thereof. Accordingly, forming technologies that provide improved visible surface quality, including coated films can be used since the trim back plate or carrier 14 does not itself require structural characteristics.

FIG. 2 shows an alternative exemplary embodiment of a trim module 10 based on a first layer or structural member 12 and a low content door trim 17 wherein the trim base carrier 14 and trim 16 are merged into a single series of the components each of which having reduced structural properties through the implementation of structural member 12.

Accordingly, various exemplary embodiments: eliminate structure areas and elements which are in some applications duplicated due to rail systems being secured to door modules and thus the structural member 12 is optimized using cost efficient molding technologies such as compression or injection molding. In one embodiment, a structural member 12 is provided that uses and integrates structural elements that are already necessary for a door module (e.g., window guide rails, run channels, belt line area bars, etc.) to provide design and styling flexibility for different content and/or markets. Furthermore and by using this manufacturing process, the structural member can be manufactured by a process that permits the implementation of high volume production and assembling technologies (for example, material from coils as well as automated production and assembling technologies). Still further, this process allows for the implementation of high volume cost effective trim technologies, for example, thermo forming, back injection molding, back compression molding, film coating, etc. Since the trim pieces no longer require structural characteristics. Use of these processes allows for reduced weight and costs and enables automated assembling of wherein the door system may have multiple variations (e.g., different content, markets, etc.).

Other components secured to the door module 10 include a vehicle door latch assembly 70, associated Bowden cable 71, wiring harnesses 72 and various trim components including but not limited to a speaker cover 74, an inner door handle 76, a storage pocket 78 and associated closing bracket 80 as well as a closing bracket 82 for the map pocket 40, a basic carrier 84 and various coverings 86 configured to be disposed proximate to arm rest portions and top portions of the door module.

As discussed herein, a multiple layer trim door module for vehicle door is provided, wherein: a separately formed structural member having at least one column and at least one bar crossing each other to form a structural space frame grid are formed by a plastic molding process or a plastic injection molding process wherein the at least one column and at least one bar have a first structural rigidity associated therewith; and a separately formed trim back plate with reduced structural properties is attached to the structural member, wherein the separately formed trim back plate is formed by a plastic molding process or a plastic injection molding process and the separately formed trim back plate has a second structural rigidity associated therewith, the second structural rigidity being less than the first structural rigidity; and door trim with reduced structural properties is provided for attachment to trim back plate, wherein the door trim has a third structural rigidity associated therewith, third structural rigid the being less than the first structural rigidity.

Accordingly, a structurally sound door module is provided wherein structural stability is provided by a structural member having a reduced sized figuration including integrally formed columns and rows to provide a spaced frame configuration. Structural member is then secured to a second trim base carrier that is formed from a molding process that provides the trim base carrier with reduced structural characteristics as opposed to those of the structural member such that manufacturing processes providing enhanced aesthetically pleasing components can be utilized since structural rigidity of these components is not necessary. Still further, trim portions are then secured to the trim base carrier and the assembled door module is secured to a vehicle door.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A multiple layer trim door module for vehicle door, comprising:
a separately formed structural member having at least one column and at least one bar crossing each other to form a structural space frame grid, wherein the separately formed structural member is formed by a plastic molding process wherein the at least one column and at least one bar have a first structural rigidity associated therewith;
a separately formed trim back plate with reduced structural properties attached to the structural member, wherein the separately formed trim back plate is formed by a plastic molding process and the separately formed trim back plate has a second structural rigidity associated therewith, the second structural rigidity being less than the first structural rigidity; and
door trim with reduced structural properties attached to trim back plate, wherein the door trim has a third structural rigidity associated therewith, third structural rigid the being less than the first structural rigidity.

2. The multiple layer trim door module as in claim 1, wherein the at least one bar defines an upper belt line of the multiple layer trim door module and the structural member further comprises a lower trim support and mid structure located between the at least one bat and the lower trim support.

3. The multiple layer trim door module as in claim 2, wherein the structural member also contains and integrates a diagonal cable guide.

4. The multiple layer trim door module as in claim 3, wherein the structural member is configured to support anyone of the following: cable window lift parts; door trim parts; a drum housing; an electric motor; cable guides; pulleys; studs; a speaker; an armrest; a map-pocket; routing channels; and fastening devices for different housings and components (electric wiring, electronic devices etc.).

5. The multiple layer trim door module as in claim 4, wherein the structural member is formed from a fiber reinforced plastic.

6. The multiple layer trim door module as in claim 1, wherein the structural member is reinforced by additional mould-in inlays selected from the group consisting of: metal, glass mat, plastic, and combinations thereof.

7. The multiple layer trim door module as in claim 1, wherein the structural member also contains and integrates a diagonal cable guide.

8. The multiple layer trim door module as in claim 7, wherein the structural member is configured to support anyone of the following: cable window lift parts; door trim parts; a drum housing; an electric motor; cable guides; pulleys; studs; a speaker; an armrest; a map-pocket; routing channels; and fastening devices for different housings and components (electric wiring, electronic devices etc.).

9. The multiple layer trim door module as in claim 1, wherein the structural member is formed from a fiber reinforced plastic.

10. The multiple layer trim door module as in claim 1, wherein the wherein the trim back plate provides back areas for the door trim and wherein the plastic molding process is a plastic injection molding process.

11. The multiple layer trim door module as in claim 1, wherein the structural member has a plurality of first mounting features configured for securing the structural member to the door module.

12. The multiple layer trim door module as in claim 11, wherein the structural member has a plurality of second mounting features configured for securing the structural member to the trim base carrier.

13. The multiple layer trim door module as in claim 12, wherein the plurality of second mounting features are integral tab members formed with the columns and bars and the integral tab members extend outwardly away from the structural member such the structural member is spaced from a surface of the trim base carrier when the structural member is secured to the base carrier via the plurality of second mounting features and wherein the door trim is secured to the separately formed structural member.

14. The multiple layer trim door module as in claim 11, wherein the plurality of first mounting features are integral tab members formed with the columns and bars and the integral tab members extend outwardly away from the structural member such the structural member is spaced from a surface of the door module when the structural member is secured to the door module via the plurality of first mounting features.

15. A method forming a multiple layer trim door module, comprising:
separately forming a structural member having at least one column and at least one bar crossing each other to form a structural space frame grid, wherein the separately formed structural member is formed by a plastic molding process wherein the at least one column and at least one bar have a first structural rigidity associated therewith;
separately forming a trim back plate with reduced structural properties attached to the structural member, wherein the separately formed trim back plate is formed by a plastic molding process and the separately formed trim back plate has a second structural rigidity associated therewith, the second structural rigidity being less than the first structural rigidity;
forming door trim with reduced structural properties, wherein the door trim has a third structural rigidity associated therewith, the third structural rigid the being less than the first structural rigidity;
securing the separately formed structural member to the separately formed trim back plate; and
securing the door trim to the separately formed trim back plate.

16. The method as in claim 15, wherein the at least one bar defines an upper belt line of the multiple layer trim door module and the structural member further comprises a lower trim support and mid structure located between the at least one bat and the lower trim support.

17. The method as in claim 15, wherein the structural member also contains and integrates a diagonal cable guide.

18. The method as in claim 15, wherein the structural member is formed from a fiber reinforced plastic.

19. The method as in claim 15, wherein the structural member is reinforced by additional mould-in inlays selected from the group consisting of: metal, glass mat, plastic, and combinations thereof.

20. The method as in claim 15, wherein the structural member has a plurality of first mounting features configured for securing the structural member to the door module and wherein the structural member has a plurality of second mounting features configured for securing the structural member to the trim base carrier and the plastic molding process is a plastic injection molding process.
